(19) United States
(12) Patent Application Publication
(10) Pub. No.: US 2025/0375700 A1
(43) Pub. Date: Dec. 11, 2025

(54) APPARATUS AND METHOD OF APPLICATION CONTROL

(71) Applicant: Sony Interactive Entertainment Inc., Tokyo (JP)

(72) Inventors: Paul Terence Mulligan, London (GB); Matthew Corrall, London (GB)

(21) Appl. No.: 19/228,428

(22) Filed: Jun. 4, 2025

(30) Foreign Application Priority Data
Jun. 11, 2024 (GB) 2408338.8

(51) Int. Cl. A63F 13/22; A63F 13/327; A63F 13/355; A63F 13/44; A63F 13/843

(52) U.S. Cl. CPC A63F 13/22; A63F 13/327; A63F 13/355; A63F 13/44; A63F 13/843

(57) ABSTRACT

A method of interactive control comprises the steps of establishing connection with two or more controllers, comprising at least a first controller and a second controller, receiving inputs from the first controller to interact with a single-user application, initializing a control swap scheme, the scheme comprising selecting inputs from the first controller to provide to the single-user application as inputs from the first controller, and in response to a predetermined criterion, selecting inputs from the second controller to provide to the single-user application as inputs from the first controller.

### CROSS REFERENCE

The present application claims priority to United Kingdom (GB) Application No. 2408338.8, filed Jun. 11, 2024, the contents of which is incorporated by reference herein in its entirety for all purposes.

### FIELD OF INVENTION

The present invention relates to an apparatus and method of application control.

### BACKGROUND

There are many types of multiplayer games, some based on multiple clients connecting via a server, and others based on multiple participants using the same local client machine.

Meanwhile some games provide an optional or non-critical role for a second player (e.g. collecting items, or moving obstacles), but these are game specific can be thought of as another class of local multiplayer game.

However, many games are designed as single-player experiences, which if played by one person can leave friends or family members without the scope to participate.

The present disclosure addresses or mitigates this problem.

### SUMMARY

The present disclosure provide a method of interactive control. The method comprises establishing connection with two or more controllers comprising at least a first controller and a second controller; receiving inputs from the first controller to interact with a single-user application; initializing a control swap scheme. The scheme comprises: selecting inputs from the first controller to provide to the single user application as inputs from the first controller; and in response to a predetermined criterion, selecting inputs from the second controller to provide to the single user application as inputs from the first controller.

The predetermined criterion can be the elapse of a period of time. For example, a countdown to the elapse of the period of time can be indicated to users of the controllers.

In some embodiments, during a predetermined period preceding the elapse of the period of time, the control swap scheme comprises selecting at least a subset of inputs from the first controller and the second controller to both provide to the single user application as inputs from the first controller.

In some embodiments, during a predetermined period following the elapse of the period of time, the control swap scheme comprises: selecting at least a subset of inputs from the first controller and the second controller to both provide to the single user application as inputs from the first controller.

The predetermined criterion can relate to an operation of the single-user application.

The control swap scheme can include: selecting only a subset of inputs from the second controller to provide to the single user application as inputs from the first controller.

The control swap scheme can include: in response to a predetermined criterion, selecting inputs from the first controller to provide to the single user application as inputs from the first controller. For example, the predetermined criterion can be receipt of an override input from the first controller.

In some embodiments, if an input focus is not directed at the single user application, the method comprises selecting inputs from the first controller.

In some embodiments, establishing connection with the second controller includes establishing a remote connection with the second controller over a network; and the method includes: streaming an output of the application over the network to a remote device associated with the second controller, and receiving inputs from the second controller over the network.

The present disclosure provides a non-transitory, computer readable storage medium containing a computer program comprising computer executable instructions that when executed by a computer system, cause the computer system to perform a method of interactive control. The method comprises: establishing connection with two or more controllers, comprising at least a first controller and a second controller; receiving inputs from the first controller to interact with a single-user application; initializing a control swap scheme. The scheme can include: selecting inputs from the first controller to provide to the single user application as inputs from the first controller; and in response to a predetermined criterion, selecting inputs from the second controller to provide to the single user application as inputs from the first controller.

The present disclosure provides a processing device for interactive control of an application. The processing device comprises: a data port configured to establish connection with two or more controllers, comprising at least a first controller and a second controller; the data port being configured to receive inputs from the first controller to interact with a single-user application; a swap processor, configured to initialize a control swap scheme; the swap processor being configured to select inputs from the first controller to provide to the single user application as inputs from the first controller; and the swap processor being configured, in response to a predetermined criterion, to select inputs from the second controller to provide to the single user application as inputs from the first controller.

The predetermined criterion can relate to one or more selected from the list consisting of: the elapse of a period of time, an operation of the single-user application, and receipt of an override input from the first controller.

In some embodiments, if an input focus is not directed at the single user application, the swap processor is configured to select inputs from the first controller.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a processing device such as an entertainment device, in accordance with embodiments of the present description.

FIG. 2 is a schematic diagram of a controller, in accordance with embodiments of the present description.

FIGS. 3A and 3B are diagrams of a user interface for a swap scheme, in accordance with embodiments of the present description.

FIG. 4 comprises diagrams of a user interface for a swap scheme, in accordance with embodiments of the present description.

FIG. 5 is a schematic diagram of system comprising a processing device such as an entertainment device, in accordance with embodiments of the present description.

FIG. 6 is a flow diagram of a method of interactive control, in accordance with embodiments of the present description.

### DETAILED DESCRIPTION

An apparatus and method of application control are disclosed. In the following description, a number of specific details are presented in order to provide a thorough understanding of the embodiments of the present disclosure. It will be apparent, however, to a person skilled in the art that these specific details need not be employed to practice the present disclosure. Conversely, specific details known to the person skilled in the art are omitted for the purposes of clarity where appropriate.

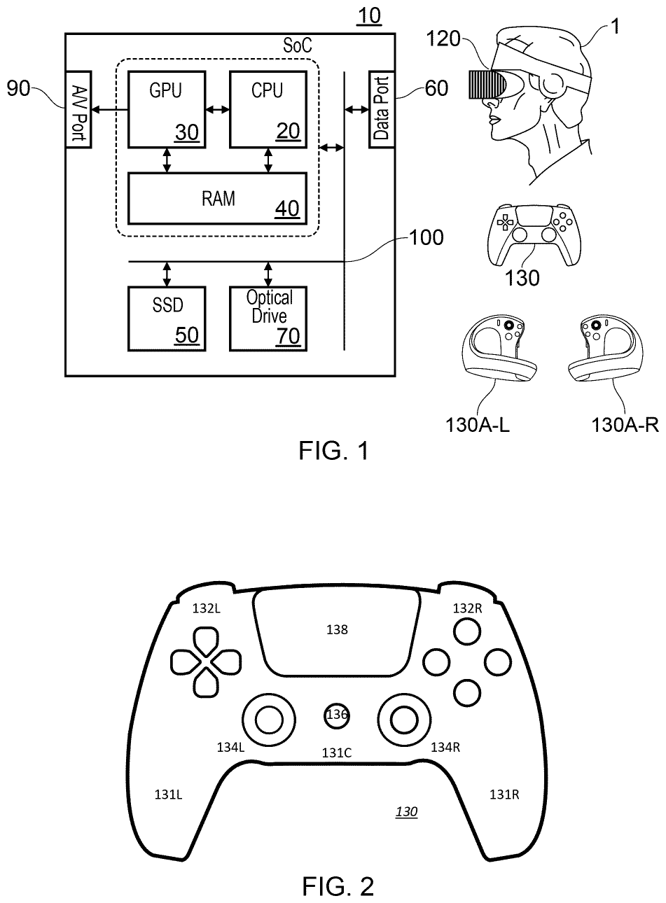

Referring now to the drawings, wherein like reference numerals designate identical or corresponding parts throughout the several views, FIG. 1 shows an example of an entertainment system 10 such as a computer or console.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50.

The entertainment device may transmit or receive data via one or more data ports 60. It may also optionally receive data via an optical drive 70. Audio/visual outputs from the entertainment device are typically provided through one or more A/V ports 90 or one or more of the data ports 60. Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

FIG. 2 shows an example of the handheld controller 130. Such a controller typically has two handle sections 131L, R and a central body 131C. Various controls are distributed over the controller, typically in local groups. Examples include a left button group 132L, which may comprise directional controls and/or one or more shoulder buttons, and similarly right button group 132R, which comprises function controls and/or one or more shoulder buttons. The controller also includes left and/or right joysticks 134L,R, which may optionally also be operable as buttons by pressing down on them.

The controller (typically in the central portion of the device) may also comprise one or more system buttons 136, which typically cause interaction with an operating system of the entertainment device rather than with a game or other application currently running on it; such buttons may summon a system menu, or allow for recording or sharing of displayed content. Furthermore, the controller may comprise one or more other elements such as a touchpad 138, a light for optical tracking (not shown), a screen (not shown), haptic feedback elements (not shown), and the like.

As noted previously herein, some games are single-player experiences. This can be frustrating for users where, for example, there are siblings or friends, or parents and children, who may wish to interact with a game.

When playing a single player game, typically only one user is using a controller. In principle, this user could pass the controller to another person, thereby sharing play of the game—however this is not always practical to do, since often game play is time-critical (for example, by the time the controller has been passed to another player, the in-game avatar of the player may have been killed, or taken damage, or lost a race position or missed a track corner). Similarly the act of passing a controller from one user to another can result in unwanted activation of an input, for example nudging a joystick or depressing a shoulder button, resulting in unwanted or unintended effects. As a result, physical sharing of controls is often undesirable.

Meanwhile, if a second user activates a second controller, they often have limited input, even to the OS; typically there is a notional user who is in control or whose account is in focus, who can access the OS and who typically also started and is playing the single player game. Consequently whilst the second user may have an active control associated with them on the entertainment device, they cannot significantly interact with the device beyond a limited set of functions, and typically cannot interact with the single player game at all.

Accordingly in embodiments of the present description, the operating system of the entertainment device, or a helper app of the operating system or accessible by or for it, provides a means for multiple users to interact with the single player game.

Hereafter, the operating system or the helper app are referred to generically as the OS.

As noted previously each user interacts with a respective controller, and the controller is associated with the user's account (or denotes them as a guest user). Consequently inputs from each user are identifiable by the OS.

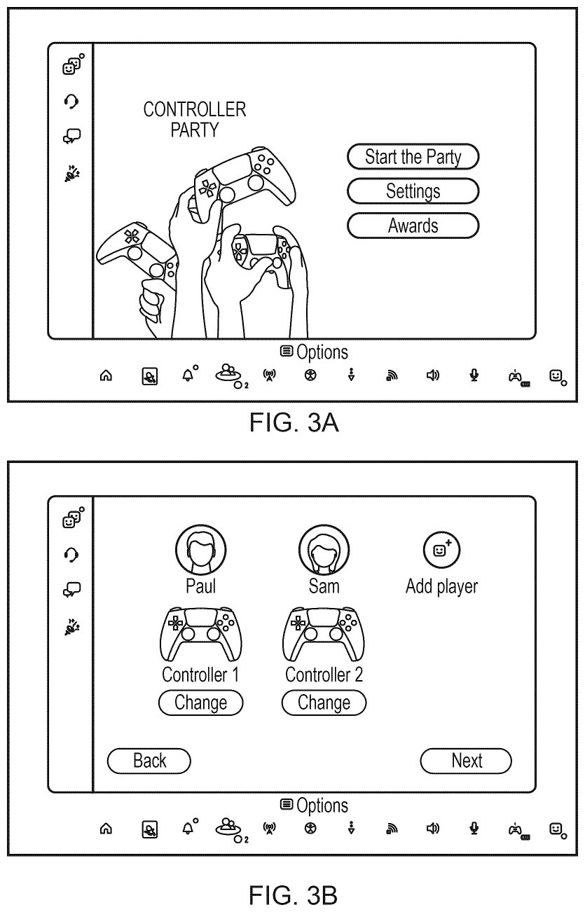

Referring now to FIGS. 3A and 3B, the OS can provide a party mode, adding two or more users and their corresponding controllers to the party.

Subsequently, the OS can intercept inputs from the controllers of the users, and either block them, or reallocate them, as follows.

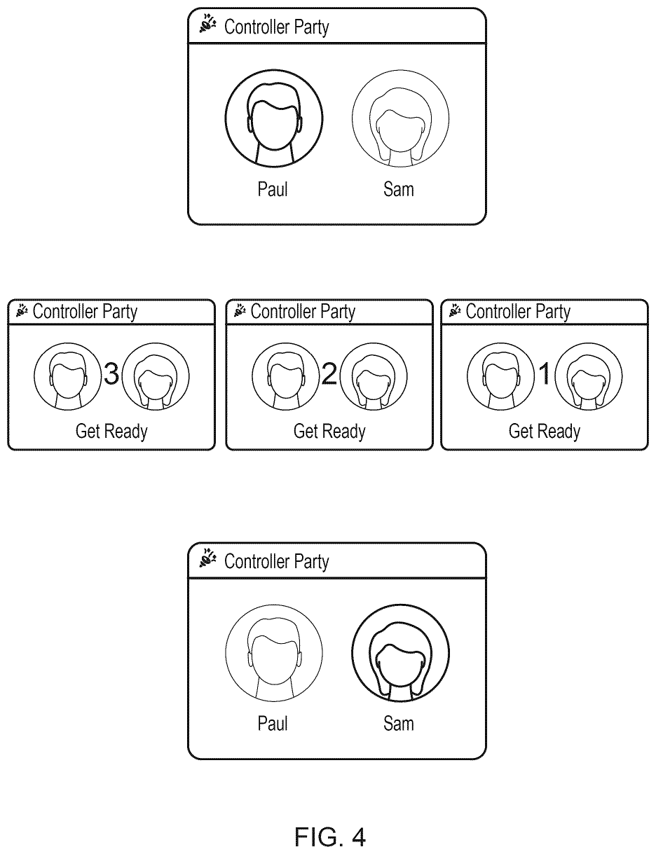

Referring now to FIG. 4, this illustrates a non-limiting example of operation of the OS in this party mode. In the upper figure of FIG. 4, the party members are shown in an overlay provided by the OS on top of (or to one side of) the single player game. Initially, one player (typically the original single player, ‘Paul’) is highlighted.

In this case, inputs from the original single player's controller are passed to the single player game as normal.

Subsequently, after a predetermined period of, for example 15, 20, 30, 45, 60, 90, 120, 180, 240, or 300seconds, the OS causes the overlay to notify the users that control of the single player game is about to be reallocated (in the case of two players, swapped), for example by counting down from 10, 5 or 3 seconds to the reallocation.

Afterwards, the next player (‘Sam’) is highlighted.

At the same time, inputs from the first player Paul's controller are now intercepted and no longer forwarded to the single player game. Instead, inputs from the second player Sam's controller are intercepted and forwarded to the single player game, appearing to the single player game as if from the first player.

It will be appreciated that receiving and processing inputs from controllers is generally an OS function and hence intercepting and forwarding the next player's inputs may be achieved for example by the OS changing the source controller whose data is supplied to an input API of the single player game, or by replacing a signal feed associated with the first controller with a signal feed (or a copy of a signal feed) from the second controller.

The upshot is that the single player game continues to function transparently and receive inputs that are apparently from the same user, whilst the actual control has passed from the first user to the second user, as coordinated by the OS on the entertainment device and shown on the user interface of the overlay.

In this way, control of the game can be shared seamlessly, and without the need for physical sharing of a controller.

This last point also allows for one or more party members to be remote (for example, a remote user on an online friend list of the first player). In this case, the party mode helper app or OS feature causes the graphical output of the entertainment device to be streamed from the first user to the or each participating remote friend, for example via a peer-to-peer link or via a streaming distribution server to the respective entertainment devices of those remote friends (for example in the case of a cloud-hosted game). In this case, the inputs from the or each remote friend are then transmitted back to the entertainment device of the first user (whether local or a cloud instance), and then treated as per other local controllers in the party mode.

Optionally in this case voice chat or other communication channels may also be active and similarly distributed so that a communal experience is enabled.

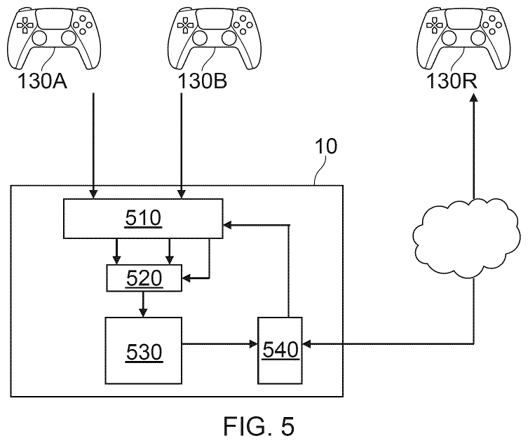

Referring now to FIG. 5, in embodiments of the present description, the entertainment device 10 comprises a controller I/O unit 510, for example as part of data port 60 and/or CPU 20 or optionally a chip ‘SoC’ comprising it. This I/O unit may take the wired or wireless inputs from local controllers 130A and 130B. The entertainment device further comprises an input routing unit 520, which may for example be CPU 20 operating under suitable software instruction, to select inputs from one controller to relay (optionally after any standard processing or parsing) to the game 530. The input routing unit implements the techniques herein, optionally in conjunction with or as part of an OS feature or helper app as described elsewhere herein.

Optionally, where a further friend is participating remotely, output from the game (e.g. audio and video) may be streamed using a streaming I/O unit 540, comprising for example the GPU, CPU, and data port 60 operating under suitable software instruction. The output is streamed via a network (typically the internet) to the remote user's entertainment device (not shown) where inputs from their controller 130R are then transmitted back to the entertainment device via the network. These inputs are received (e.g. for example by the data port and CPU) acting either as the streaming I/O unit or as the controller I/O unit 510, or a combination of the two. The inputs from the remote user's controller can then be selected in a similar manner to the inputs of the local controller.

In any case, it will be appreciated that this enables interaction with a single player game to be shared between players when it would otherwise be impractical to share a physical controller.

The handover between the current player and the next player may include a period where inputs from both controllers, or some inputs from both controllers, are provided to the single player game as if from the first player. This period may include some or all of the countdown period, and/or a short period after the notional swap has taken place.

This joint control can mitigate several issues. This first is if an input needs to be continuous to count in the game—for example charging up a spell may require a continuous press of a key; letting either player's activation of that key count can make it easier for a continuous input to be registered by the game.

Hence optionally the inputs for at least a first physical input of the controllers may be treated as a logical ‘OR’, so that either or both inputs is treated as the input.

Meanwhile some inputs may be excluded from this scheme, or only be conditionally a logical OR; for example if the two users try to move in opposing directions, optionally only the direction provided by the notional current player is input. This is because normally it is not physically possible to input diametrically opposed inputs and so typically a game is not designed to handle this instance and may behave unpredictably.

Meanwhile where input commands are contradictory (for example pressing ‘shield’ and ‘fire’ where the game does not allow it), then optionally input from the notional current player is input. However, here alternatively the game itself may be allowed to handle such inputs according to any internal rules, if the commands could in principle be input simultaneously in normal use. This means the sharing scheme still operates independently without reference to the game at all.

Hence more generally, optionally during the countdown period, where two inputs could not be physically provided by a single player on the controller, the inputs of the notional current player are provided to the game, whereas for other inputs typically they are provided on a logical ‘OR’ basis. Similarly optionally this scheme may also applied for a short period after the handover as well (e.g. for 1, 2, or 3 seconds).

The second issue is when an input sequence is required for a specific operation within in the game—a so-called ‘combo’. It may be helpful for a user part-way through a combo to be able to complete it, even if the handover has notionally occurred. Having the scheme also apply for a short period after the handover as well (e.g. for 1, 2, or 3 seconds) helps to complete such multi-step inputs.

Such schemes may be selected as part of the rules for the sharing scheme, either explicitly or as part of a difficulty setting (for example, sharing responsibility for a combo move is more difficult than letting someone complete it).

Hence for example the settings may include:
No handover overlap of control;
Overlap of full or partial control during a predestined period preceding handover (e.g. during the countdown); and
Overlap of full or partial control during a predestined period after handover.

The trigger for handing over to another player may be time based (e.g. periodic as noted previously herein, or random, optionally within a time range of, for example, 10 to 60 seconds), but may also be event based; for example when the game character dies, or reaches a save point, or the like; these changes in game states can be monitored by the OS, for example based on what assets are loaded/used by the game, or based on event flags provided in an API. The use of an API again means that such events are abstracted away from the specific game.

Notably the swap scheme is not responsive to any handover within the game itself; hence if the game is not truly single player but in fact allows play by player one, and then by player two (for example taking turns to complete a race), and normally accepts inputs from these players respective controllers, then this is independent of the swap scheme.

Similarly for games that have an optional second player (typically one who controls a non-critical game function such as being able to collect items that the main player can also collect), typically because the swap scheme only provides inputs as the first player, the optional second player role is not activated—or if so, is assigned to a further player who is not part of the swap scheme.

Also optionally a user could force a handover, either immediately or within a short following period, for example by pressing a specific button on their own controller for a predetermined period. This could be of use for example where a remote player's connection has failed and it is desirable to wrest control back, or simply as a way of acquiring control on demand. Optionally, this facility may be limited to the original user whose account is notionally being played upon, so that they can reclaim control as desired.

Optionally, the scheme herein may be subject to security features, as follows. The handover of control to a second party (or the continued control by that second party) may be conditional on the control only applying to the main game features. Hence or example if a setting menu or a load or save menu are accessed, control immediately reverts to the original user whose account is notionally being played upon. In this way there is less scope for permanent changes to be made to the game by other parties.

Similarly, control by a second party may not apply to OS features accessible by the game, such as starting or storing video recordings, or sharing such recordings, or activating voice chat or the like. Similarly attempts to access the OS interface may be ignored, or may cause control to revert to the original user whose account is notionally being played upon.

In this way second parties cannot negatively impact the first player, in terms of for example deleting as save game, or selecting a UI language that the first player does not understand, or making unauthorised purchases. The second parties could, or course, still play badly (or well) during the game, and this is part of the interactive experience for the players.

Similarly, the swap scheme as shown in FIGS. 3A and 3B may be set up during use of the game (for example pressing a button to access the swap scheme interface), or may be set up beforehand; in this latter case, the swap scheme typically will not activate immediately as the user is not within the game. Similarly the swap scheme may not start until the first user provides an input to indicate it should, so that they can navigate menus and options of the game, load a game state, and/or navigate to a point in the game where they want the swap scheme to start.

It will be appreciated that the above scheme is independent of the game or games being played; the graceful handover of control input is specifically intended to have no effect on the game itself and does not affect how it works or progresses. Rather, it enables a handover of control where this would be physically difficult either due to time constraints (at a critical moment), handling constraints (inadvertent activation of inputs), or distance constraints (one or more other parties being remote from the first user).

### Variants

By implementing a logical swap of control the swapping scheme is not as constrained in the degree and nature of handover as is the case in a physical swap of controls.

In particular, optionally only a subset of controls may be swapped; for example directional movement control may be swapped from 1^{st} to 2^{nd} parties, whilst firing or jumping controls are swapped from 2nd to 1^{st} parties; this allows for continuous sharing of the game between parties whilst also periodically changing their role.

Similarly, and as noted elsewhere herein, the periodicity of swaps can be randomised, so that it comes as more of a surprise to users. Optionally the countdown may be omitted, and just the change status updated—or optionally even this may be omitted so that users only know a swap has occurred by the change in response to control inputs.

For games that are multiplayer, in principle the swap scheme can still be used; hence for example three people could play a two player game, by having player 1 be swapped between two users as described elsewhere herein. Similarly this approach could be extended so that for example four people could play a two player game by also having player 2 be swapped between two users as described elsewhere herein.

One specific case of this is where two users play a two player both being swappable for both players; In this way, the users in effect swap roles in the game; each one is swapping control of a notional player in the game in a complementary pattern.

Hence more generally inputs from two or more players can be assigned for swapping in as the inputs for any nominated player according to the swap scheme. Typically the nominated player will still be one of the two or more assigned players.

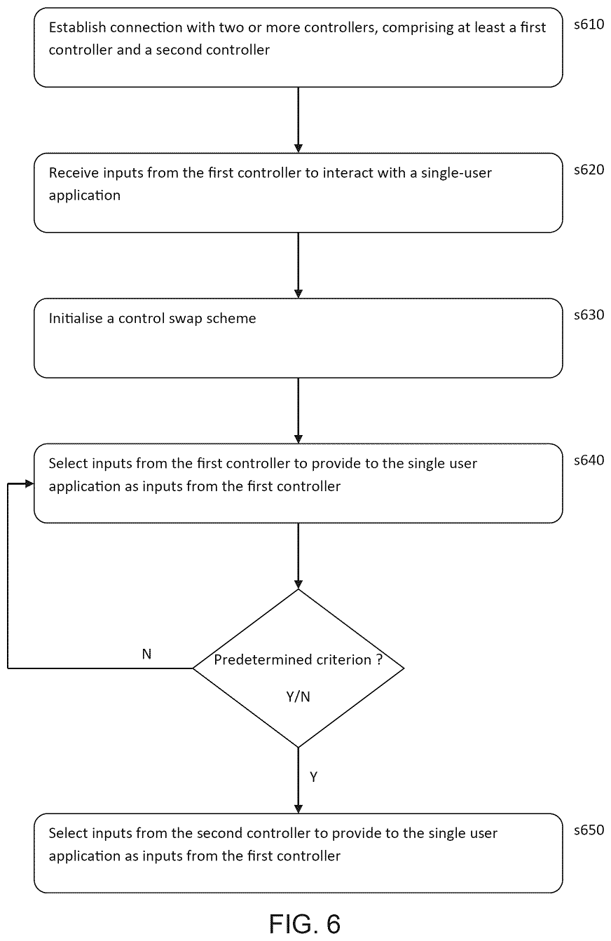

Referring now to FIG. 6, in a summary embodiment of the present description a method of interactive control comprises the following steps.

In a first step s610, establish connection with two or more controllers (e.g. local wired or wireless controllers, and/or remote controllers via a network), comprising at least a first controller and a second controller, as described elsewhere herein.

In a second step s620, receiving inputs from the first controller (typically that of the device owner, and/or first, or main, account holder) to interact with a single-user application (for example a game, but not limited to games), as described elsewhere herein.

In a third step s630, initializing a control swap scheme, as described elsewhere herein. it will be appreciated that the control swap scheme may be initialized before step 620, as also described elsewhere herein.

The scheme comprises, at fourth step s640, selecting inputs from the first controller to provide to the single user application as inputs from the first controller, as described elsewhere herein.

In response to a predetermined criterion, then at a fifth step s650, selecting inputs from the second controller to provide to the single user application as inputs from the first controller, as described elsewhere herein; as a result control of the single-user application is swapped from the first user to the second user in a manner that is transparent to the single-user application, that continues to behave as if it is receiving inputs from the same (first) user.

It will be apparent to a person skilled in the art that variations in the above method corresponding to operation of the various embodiments of the apparatus as described and claimed herein are considered within the scope of the present disclosure, including but not limited to that:
the predetermined criterion is the elapse of a period of time, as described elsewhere herein;
   in this instance, optionally a countdown to the elapse of the period of time is indicated to users of the controllers, as described elsewhere herein;
   similarly in this instance, optionally during a predetermined period preceding the elapse of the period of time, the control swap scheme comprises selecting at least a subset of inputs from the first controller and the second controller to both provide to the single user application as inputs from the first controller, as described elsewhere herein;
   similarly in this instance, optionally during a predetermined period following the elapse of the period of time, the control swap scheme comprises selecting at least a subset of inputs from the first controller and the second controller to both provide to the single user application as inputs from the first controller, as described elsewhere herein;
the predetermined criterion relates to an operation of the single-user application (e.g. performing an auto-save or asset loading function, such as when performing so-called fast travel, or encountering a boss fight, as described elsewhere herein;
the control swap scheme comprises selecting only a subset of inputs from the second controller to provide to the single user application as inputs from the first controller, as described elsewhere herein;
the control swap scheme comprises, in response to a predetermined criterion, selecting inputs from the first controller to provide to the single user application as inputs from the first controller, as described elsewhere herein;
   in this instance, optionally the predetermined criterion is receipt of an override input from the first controller, as described elsewhere herein;
if an input focus is not directed at the single user application (e.g. inputs will be interpreted as controls to the operating system or another application), the method comprises selecting inputs from the first controller (e.g. as a security measure), as described elsewhere herein; and
the step of establishing connection with the second controller comprises establishing a remote connection with the second controller over a network, and the method comprises the steps of streaming an output of the application over the network to a remote device associated with the second controller, and receiving inputs from the second controller over the network, as described elsewhere herein.

It will be appreciated that the above methods may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, in a summary embodiment of the present description, and referring again to FIGS. 1 and 5, a processing device (e.g. entertainment device 10, or any suitable device capable or running a single user application and receiving inputs from the control devices of two users), for interactive control of an application 530, comprises the following.

A data port (e.g. data port 60, or equivalently controller I/O unit 510, or one acting as the other) configured (for example by suitable software instruction) to establish connection with two or more controllers, comprising at least a first controller and a second controller (for example controllers 130A and 130B), as described elsewhere herein.

The data port is configured (for example by suitable software instruction) to receive inputs from the first controller to interact with a single-user application, as described elsewhere herein.

A swap processor (e.g. CPU 20, or equivalently input routing unit 520, or one acting as the other), configured (for example by suitable software instruction) to initialize a control swap scheme, as described elsewhere herein.

The swap processor is configured (for example by suitable software instruction) to select inputs from the first controller 130A to provide to the single user application 530 as inputs from the first controller 130A, as described elsewhere herein.

The swap processor is similarly configured (for example by suitable software instruction), in response to a predetermined criterion, to select inputs from the second controller 130B to provide to the single user application as inputs from the first controller 130A, as described elsewhere herein.

Instances of this summary embodiment implementing the methods and techniques described herein (for example by use of suitable software instruction) are envisaged within the scope of the application, including but not limited to that:
the predetermined criterion relates to one or more selected from the list consisting of the elapse of a period of time, an operation of the single-user application, and receipt of an override input from the first controller, as described elsewhere herein;
if an input focus is not directed at the single user application, the swap processor is configured to select inputs from the first controller, as described elsewhere herein; and
the data port (e.g. data port 60, or equivalently streaming I/O unit 540, or one acting as the other) is configured (for example by use of suitable software instruction) to establish connection with the second controller over a network, and the data port is configured (for example by use of suitable software instruction) to stream an output of the single user application over the network to a remote device associated with the second controller, and receive inputs from the second controller over the network, as described elsewhere herein.

The foregoing discussion discloses and describes merely exemplary embodiments of the present disclosure. As will be understood by those skilled in the art, the present invention may be embodied in other specific forms without departing from the spirit or essential characteristics thereof. Accordingly, the present disclosure is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of interactive control, comprising:
establishing connection with two or more controllers comprising at least a first controller and a second controller;
receiving inputs from the first controller to interact with a single-user application;
initializing a control swap scheme, the scheme comprising:
selecting inputs from the first controller to provide to the single-user application as inputs from the first controller; and
in response to determining that a predetermined criterion is met,
selecting inputs from the second controller to provide to the single-user application as inputs from the first controller.

2. The method of claim 1, wherein the predetermined criterion is an elapse of a period of time.

3. The method of claim 2, further comprising indicating a countdown to the elapse of the period of time to users of the controllers.

4. The method of claim 2, wherein
during a predetermined period preceding the elapse of the period of time, the control swap scheme comprises:
selecting at least a subset of inputs from the first controller and the second controller to both provide to the single-user application as inputs from the first controller.

5. The method of claim 2, wherein
during a predetermined period following the elapse of the period of time, the control swap scheme comprises:
selecting at least a subset of inputs from the first controller and the second controller to both provide to the single-user application as inputs from the first controller.

6. The method of claim 1, wherein the predetermined criterion relates to an operation of the single-user application.

7. The method of claim 1, wherein the control swap scheme comprises:
selecting only a subset of inputs from the second controller to provide to the single-user application as inputs from the first controller.

8. The method of claim 1, wherein the control swap scheme further comprises:
in response to determining that the predetermined criterion is met,
selecting inputs from the first controller to provide to the single-user application as inputs from the first controller.

9. The method of claim 8, wherein the predetermined criterion is receipt of an override input from the first controller.

10. The method of claim 1, wherein the input from the first controller is selected in response to determining that an input focus is not directed at the single-user application.

11. The method of claim 1, wherein
establishing connection with the second controller comprises establishing a remote connection with the second controller over a network;
and the method comprises:
streaming an output of the single-user application over the network to a remote device associated with the second controller; and
receiving inputs from the second controller over the network.

12. A non-transitory, computer readable storage medium containing a computer program comprising computer executable instructions that when executed by a computer system, cause the computer system to perform operations comprising:
establishing connection with two or more controllers, comprising at least a first controller and a second controller;
receiving inputs from the first controller to interact with a single-user application;
initializing a control swap scheme, the scheme comprising:
selecting inputs from the first controller to provide to the single-user application as inputs from the first controller; and
in response to determining that a predetermined criterion is met,
selecting inputs from the second controller to provide to the single-user application as inputs from the first controller.

13. A processing device for interactive control of an application, the processing device comprising:
a data port configured to establish connection with two or more controllers, comprising at least a first controller and a second controller;
the data port being configured to receive inputs from the first controller to interact with a single-user application;
a swap processor, configured to initialize a control swap scheme;
the swap processor being configured to select inputs from the first controller to provide to the single-user application as inputs from the first controller; and
the swap processor being configured to, in response to determining that a predetermined criterion is met, select inputs from the second controller to provide to the single-user application as inputs from the first controller.

14. The processing device of claim 13, wherein the predetermined criterion relates to one or more of:
i. an elapse of a period of time;
ii. an operation of the single-user application; or
iii. receipt of an override input from the first controller.

15. The processing device of claim 13, wherein the input from the first controller is selected in response to determining that
an input focus is not directed at the single-user application.
